(19) United States
(12) Patent Application Publication
(10) Pub. No.: US 2018/0290645 A1
(43) Pub. Date: Oct. 11, 2018

(54) AUTONOMOUS VEHICLE CONSTANT SPEED CONTROL SYSTEM

(71) Applicant: FORD GLOBAL TECHNOLOGIES, LLC, Dearborn, MI (US)

(72) Inventors: Yanan Zhao, Ann Arbor, MI (US); Chen Zhang, Canton, MI (US); Ming Lang Kuang, Canton, MI (US)

(21) Appl. No.: 15/484,584

(22) Filed: Apr. 11, 2017

(51) Int. Cl. B60W 20/12; G05D 1/00; B60W 20/13; B60W 10/06; B60W 10/08; B60W 30/14; B60W 10/26

(52) U.S. Cl. CPC B60W 20/12; B60W 2530/10; B60W 20/13; B60W 10/06; B60W 10/08; B60W 30/143; B60W 10/26; B60Y 2200/92; B60W 2510/244; Y10S 903/93; B60W 2710/06; B60W 2710/08; B60W 2550/142; B60W 2710/244; G05D 1/0088

(57) ABSTRACT

A hybrid electric vehicle includes an engine, an electric machine, and a battery, coupled to a controller(s) configured to, in response to a virtual-driver signal, predict and maintain a constant-speed from a plurality of candidate speeds, to have a lowest fuel consumption and a minimum number of battery-charge-cycles, for a predicted distance and wheel-torque-power. A predicted engine-power is established from the wheel-torque-power required to maintain the constant-speed, and to power vehicle accessories and battery charging, such that fuel consumption and battery-charge-cycles are minimized over the predicted distance at the constant-speed. The controller(s) are configured to generate the predicted distance, from one or more of position and moving-map sensors, by detecting a current location, and identifying an open-road distance between the current location and at least one detected and/or predetermined way-point. The constant-speed is also determined by evaluating travel-times and battery-charge-discharge cycles for the constant speed over the predicted distance.

### TECHNICAL FIELD

The disclosure relates to autonomous driver, constant speed systems and methods for a hybrid electric vehicle (HEV).

### BACKGROUND

In autonomous HEV systems, such as those described in part in Society of Automotive Engineering (SAE) Standard J3016 level 3 (conditional automation) and level 4 (high automation), a virtual or autonomous driver may be incorporated that enables various semi-autonomous and autonomous operations including, for example, maintaining constant speed while traversing a fixed distance. Previously, vehicle occupants were required to configure various powertrain components to maintain the constant speed, while other HEV components and systems maintained battery charging, among other operations, without regard for fuel economy, battery charging-discharging efficiency.

### SUMMARY

The present disclosure enables improved fuel economy and battery charge-discharge and charge-cycling efficiency by enabling a virtual driver and other controllers to predict and adjust optimal HEV engine and electric machine/traction motor/motor/generator settings and high-voltage (HV) battery charging rates, while predicting, adjusting, and maintaining a desired constant-speed, such that the optimal operating points (torque and speed) of the engine and electric motor can be predicted to minimize fuel consumption. For example, when the HEV is enabled for automated driving, the virtual driver can establish vehicle constant-speed and wheel-torque-power demand needed to maintain the constant-speed, and can enable adjustment of the desired constant-speed to optimize engine-power and battery-charging-power, such that fuel economy and battery charging efficiency is improved.

Fuel economy preferences can also be managed by the virtual driver system to optimize the virtual driver charge-torque demand needed to maintain a desired HV battery state of charge (SoC) range during such constant-speed operation, such that fuel consumption is further minimized. With the improved capability of the present disclosure, a constant vehicle speed within a range of speeds is predictable and maintainable by the virtual driver to maximize fuel economy, which is enabled by establishing engine and traction motor operating points that deliver the constant-speed in combination with energy management that optimally maintains engine and battery power to charge the HV battery while minimizing engine fuel consumption.

An HEV according to the disclosure includes an internal combustion engine (ICE), an electric machine/motor/generator (M/G), and a battery, coupled to one or more controller(s) that are configured to respond to a virtual-driver signal. In response, the controller(s) are configured to predict and maintain a constant-speed for the HEV and a predicted distance and a predicted wheel-torque-power, as well as engine-power and battery-power. The controllers are also modified to predict, maintain, derive, and establish an HEV constant-speed from a plurality of candidate speeds, to have a lowest fuel consumption and a minimum number of battery-charge-cycles, for a predicted wheel-torque-power or vehicle propulsive power, over the predicted distance.

Further, the controllers are configured to predict an engine-power that is required to maintain the constant-speed, to power vehicle accessories, and to generate battery-power needed to enable a charge-rate for the battery. The predicted engine-power and battery-power is utilized by the controller(s) to command the engine and M/G, and are derived from and adjusted such that fuel consumption and battery-charge-cycles are minimized over the predicted distance. The predicted engine-power is established from the wheel-torque-power required to maintain the constant-speed, and the power needed to power vehicle accessories and battery charging, such that fuel consumption and battery-charge-cycles are minimized over the predicted distance at the constant-speed. The controller(s) are configured to generate the predicted distance, from one or more of position and moving-map sensors, by detecting a current location, and identifying an open-road distance between the current location and at least one detected and/or predetermined way-point. The constant-speed is also predicted and maintained by evaluating travel-times and battery-charge-discharge cycles for the constant-speed over the predicted distance.

The controller(s) are also configured to generate the predicted distance, from one or more of a detected current position of the HEV, and moving-map sensors that establish, receive, store road information for the current and predicted future HEV locations. The controller(s) and/or the moving-map sensors also detect an open-road distance from the road information that do not have identified, selected, and/or detectable way-points, such as identified/selected way-point locations, intersections and other road obstacles that likely will require the HEV to discontinue a constant speed. The controller(s) and/or the moving-map sensors also may predict a distal-way-point of the open-road distance, which distal-way-point may be any of the noted likely locations where the constant speed is discontinued in advance of a speed change or a stop.

The current position sensor, such as a global positioning system (GPS) receiver, moving-map sensor, and/or the controller(s), are further configured to generate a plurality of constant-speeds from a range of speeds, which may be available for the predicted distance. The range of speeds may include posted speed limits included in the road information. The generated plurality of speeds are a bracketed group of a few possible constant-speeds, some a little lower and others a little higher, which would be acceptable for each of the posted speed limits. The controllers are also configured to generate respective travel-times for each of the plurality of constant-speeds, and to determine for each travel-time and constant-speed, a respective engine-power that is required to maintain each of the constant-speeds, and as a function of one or more of HEV aero drag and rolling resistance, road grade over the predicted distance, and concurrent HEV accessory loads that are likely to be required while the virtual or auto driver maintains the constant-speed.

A plurality of battery-charge-cycles and candidate cycles may also be predicted by the controller(s), using each of the respective travel-times. The predicted battery-charge-cycles and candidates are those that are required for the HEV to travel over the predicted distance, and enable the controllers to adjust the battery and to supply the required positive battery-power for propulsion over certain segments of the predicted distances, and to adjust the ICE and M/G or electric machine to recharge the battery and generate negative battery power as needed while also producing the needed engine-power for propulsion. The controller(s) also are configured to predict a plurality of engine-powers, which are required for each of the battery-charge-cycles (negative battery-power) and the required engine-power to maintain the constant-speed. With these predicted parameters, the controller(s) then are configured and able to establish a plurality of fuel consumptions for each predicted engine-power of the plurality, using specific-fuel-consumption rates from a fuel-consumption-map, such as, for example, a brake-specific-fuel-consumption map.

Thereafter, the controller(s) predict, maintain, adjust, or establish the constant-speed from the plurality of constant-speeds, which has the lowest fuel consumption and the minimum number of battery-charge-cycles of the respective pluralities. In any of the preceding configurations, the controller(s) are also arranged to generate the predicted distance, from one or more of position and moving-map sensors, by detecting a current location, and further by identifying an open-road distance between the current location and at least one predetermined way-point. Such a predetermined way-point may be identified or selected by a user via the moving-map sensor and/or related navigation systems of the HEV.

Each of the preceding variations of the disclosure also contemplate methods of operation of the HEV, that include, for example, predicting, maintaining, or establishing by the controller(s), in response to the virtual-driver signal, the constant-speed from the plurality. As before, the controller(s) predict(s), maintain(s) the constant-speed that has the lowest fuel consumption and minimum number of battery-charge-cycles, for the predicted distance and wheel-torque-power. Further, by the controller, the predicting/maintaining step includes using the predicted engine-power required for the constant-speed, vehicle accessories, battery-power and a charge-rate, over the predicted distance.

The methods further include, by the controller(s), generating the predicted distance, from one or more of position and moving-map sensors, by detecting a current location, and identifying from the moving-map sensors an open-road distance between the current location and at least one predetermined way-point. Additionally the disclosure also incorporates generating by the controller(s), the plurality of constant-speeds from a range of speeds available for the predicted distance, wherein the range of speeds is established from the one or more of position and moving-map sensors, and generating respective travel-times for each of the plurality of constant-speeds, and to determine for each travel-time and constant-speed of the pluralities, a respective required constant-speed driver power or wheel-torque-power, and engine-power and battery-power to maintain the constant-speed, and as a function of aero drag, rolling resistance, road grade, and concurrent accessory loads, among other parameters.

The controller(s) of the methods also include predicting a plurality of battery-charge-cycles and cycle candidates, using each respective travel-time, needed to enable the M/G to supply the respective required constant-speed driver or wheel-torque-power (vehicle propulsive power), battery-power, and engine-power, and predicting/establishing/identifying the lowest number of battery-charge-cycles from the plurality. Also enabled is predicting a plurality of engine-powers needed for each battery-power and battery-charge-cycle needed to maintain the constant-speed, and establishing a plurality of fuel consumptions for each predicted engine-power of the plurality, derived from and using specific-fuel-consumption rates, such as for example, those from a brake-specific-fuel-consumption map, and predicting/maintaining the constant-speed having the lowest fuel consumption from the plurality.

This summary of the implementations and configurations of the HEVs and described components and systems introduces a selection of exemplary implementations, configurations, and arrangements, in a simplified and less technically detailed arrangement, and such are further described in more detail below in the detailed description in connection with the accompanying illustrations and drawings, and the claims that follow.

This summary is not intended to identify key features or essential features of the claimed technology, nor is it intended to be used as an aid in determining the scope of the claimed subject matter. The features, functions, capabilities, and advantages discussed here may be achieved independently in various example implementations or may be combined in yet other example implementations, as further described elsewhere herein, and which may also be understood by those skilled and knowledgeable in the relevant fields of technology, with reference to the following description and drawings.

### BRIEF DESCRIPTION OF THE DRAWINGS

A more complete understanding of example implementations of the present disclosure may be derived by referring to the detailed description and claims when considered with the following figures, wherein like reference numbers refer to similar or identical elements throughout the figures. The figures and annotations thereon are provided to facilitate understanding of the disclosure without limiting the breadth, scope, scale, or applicability of the disclosure. The drawings are not necessarily made to scale.

FIG. 1 is an illustration of a hybrid electric vehicle and its systems, components, sensors, actuators, and methods of operation;

FIG. 2 illustrates certain performance aspects of the disclosure depicted in FIG. 1, with components removed and rearranged for purposes of illustration;

FIG. 3 illustrates additional aspects and capabilities of the vehicle and systems and methods of FIGS. 1 and 2, for purposes of further illustration; and

FIG. 4 depicts other aspects and describes examples and method steps that depict other operational capabilities of the disclosure of FIGS. 1, 2, and 3.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As those of ordinary skill in the art should understand, various features, components, and processes illustrated and described with reference to any one of the figures may be combined with features, components, and processes illustrated in one or more other figures to produce embodiments that should be apparent to those skilled in the art, but which may not be explicitly illustrated or described. The combinations of features illustrated are representative embodiments for typical applications. Various combinations and modifications of the features consistent with the teachings of this disclosure, however, could be desired for particular applications or implementations, and should be readily within the knowledge, skill, and ability of those working in the relevant fields of technology.

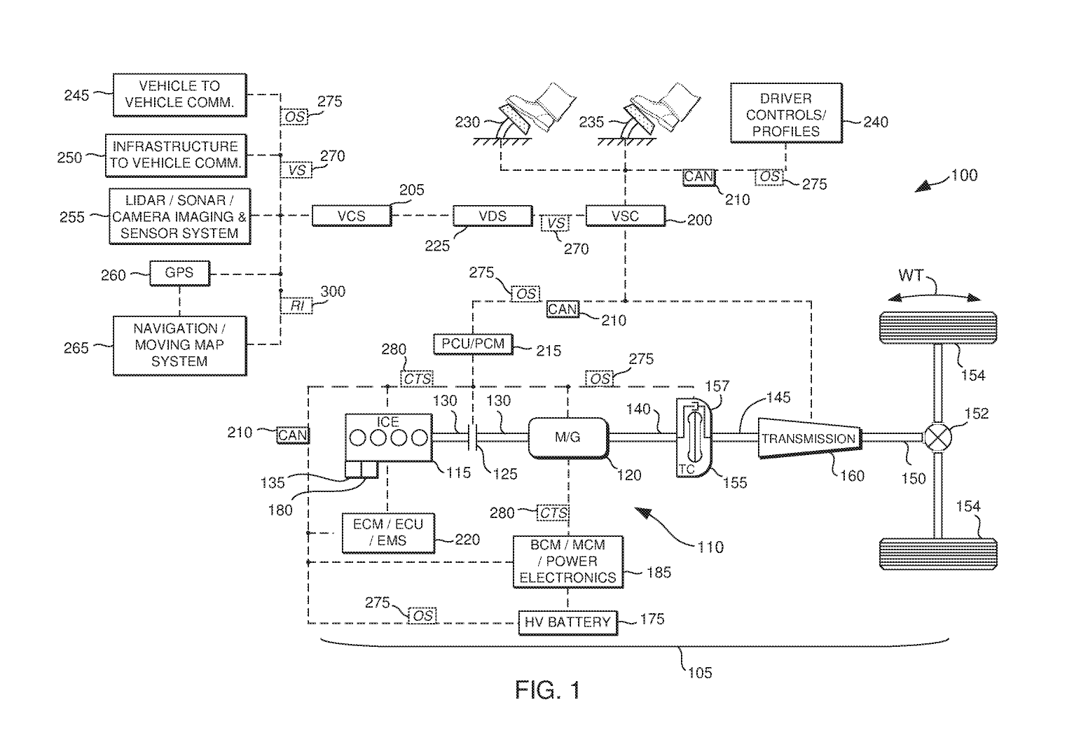

With reference now to the various figures and illustrations and to FIGS. 1, 2, 3, and 4, and specifically now to FIG. 1, a schematic diagram of a hybrid electric vehicle (HEV) 100 is shown, and illustrates representative relationships among components of HEV 100. Physical placement and orientation of the components within vehicle 100 may vary. Vehicle 100 includes a driveline 105 that has a powertrain 110, which includes an internal combustion engine (ICE) 115 and an electric machine or electric motor/generator/starter (M/G) 120, which both generate mechanical and electric power and torque to propel vehicle 100, and power HEV systems and components. Engine 115 is a gasoline, diesel, biofuel, natural gas, or alternative fuel powered engine, or a fuel cell, which generates an output torque in addition to other forms of electrical, cooling, heating, vacuum, pressure, and hydraulic power by way of vehicle, front end engine accessories and other components as described elsewhere herein. Engine 115 is coupled to electric machine or M/G 120 with a disconnect clutch 125. Engine 115 generates such power and associated engine output torque for transmission to M/G 120 when disconnect clutch 125 is at least partially engaged.

M/G 120 may be any one of a plurality of types of electric machines, and for example may be a permanent magnet synchronous motor, electrical power generator, and engine starter 120. For example, when disconnect clutch 125 is at least partially engaged, power and torque may be transmitted from engine 115 to M/G 120 to enable operation as an electric generator, and to other components of vehicle 100. Similarly, M/G 120 may operate as a starter for engine 115 with disconnect clutch 125 partially or fully engaged to transmit power and torque via disconnect clutch drive shafts 130 to engine 115 to start engine 115, in vehicles that include or do not include an independent engine starter 135.

Further, M/G or electric machine 120 may assist engine 115 in a “hybrid electric mode” or an “electric assist mode” by transmitting additional positive-propulsion power and torque to turn drive shafts 130 and 140. Also, M/G 120 may operate in an electric only mode wherein engine 115 is decoupled by disconnect clutch 125 and shut down, enabling M/G 120 to transmit positive or negative torque to M/G drive shaft 140 for forward and reverse propulsion of HEV 100. When in generator mode, M/G 120 may also be commanded to produce negative torque or power and to thereby generate electricity for charging batteries and powering vehicle electrical systems and components, while engine 115 is generating propulsion power for vehicle 100. M/G 120 also may enable regenerative braking by converting rotational, kinetic energy from powertrain 110 and/or wheels 154 during deceleration, into regenerated electrical energy for storage, in one or more batteries 175, 180, as described in more detail below.

Disconnect clutch 125 may be disengaged to enable engine 115 to stop or to run independently for powering vehicle and engine accessories, while M/G 120 generates drive or engine-power and torque to propel vehicle 100 via M/G drive shaft 140, torque convertor drive shaft 145, and transmission output drive shaft 150. In other arrangements, both engine 115 and M/G 120 may operate with disconnect clutch 125 fully or partially engaged to cooperatively propel vehicle 100 through drive shafts 130, 140, 150, differential 152, and wheels 154. Driveline 105 may be further modified to enable regenerative braking from one or more and any wheel(s) 154 using a selectable and/or controllable differential torque capability.

Drive shaft 130 of engine 115 and M/G 120 may be a continuous, single, through shaft that is part of, and integral with M/G drive shaft 140, or may be a separate, independent drive shaft 130 that may be configured to turn independently of M/G drive shaft 140, for powertrains 110 that include multiple, inline, or otherwise coupled M/G 120 configurations. The schematic of FIG. 1 also contemplates alternative configurations with more than one engine 115 and/or M/G 120, which may be offset from drive shafts 130, 140, and where one or more of engines 115 and M/Gs 120 are positioned in series and/or in parallel elsewhere in driveline 105. Driveline 105 and powertrain 110 also include a transmission 160 that includes a torque convertor (TC) 155, which couples engine 115 and M/G 120 of powertrain 110 with and/or to a transmission 160. TC 155 may further incorporate a bypass clutch and clutch lock 157.

Powertrain 110 and/or driveline 105 further include one or more batteries 175, 180. One or more such batteries can be a higher voltage, direct current battery or batteries 175 operating in ranges between about 48 to 600 volts, and sometimes between about 140 and 300 volts or more or less, which is/are used to store and supply power for M/G 120 and during regenerative braking, and for other vehicle components and accessories. Other batteries can be a low voltage, direct current battery(ies) 180 operating in the range of between about 6 and 24 volts or more or less, which is/are used to store and supply power for starter 135 to start engine 115, and for other vehicle components and accessories.

Batteries 175, 180 are respectively coupled to engine 115, M/G 120, and vehicle 100, as depicted in FIG. 1, through various mechanical and electrical interfaces and vehicle controllers, as described elsewhere herein. High voltage MIG battery 175 is also coupled to M/G 120 by one or more of a motor control module (MCM), a battery control module (BCM), and/or power electronics 185, which may include power invertors and are configured to condition direct current (DC) power provided by high voltage (HV) battery 175 for M/G 120. MCM/BCM/power electronics 185 are also configured to condition, invert, and transform DC battery power into single and multiple phase, such as three phase, alternating current (AC) as is typically required to power electric machine or M/G 120. MCM/BCM/power electronics 185 is also configured to charge one or more batteries 175, 180 with energy generated by M/G 120 and/or front end accessory drive components, and to supply power to other vehicle components as needed.

For further example, various other vehicle functions, actuators, and components may be controlled by the controllers within the vehicle systems and components, and may receive signals from other controllers, sensors, and actuators, which may include, for purposes of illustration but not limitation, fuel injection timing and rate and duration, throttle valve position, spark plug ignition timing (for spark-ignition engines), intake/exhaust valve timing and duration, front-end accessory drive (FEAD) components, transmission oil pumps, a FEAD alternator or generator, M/G 120, high and low voltage batteries 175, 180, and various sensors for battery charging or discharging (including sensors for deriving, predicting, or establishing the maximum charge, state of charge—SoC, and discharge power limits), temperatures, voltages, currents, and battery discharge power limits, clutch pressures for disconnect clutch 125, bypass/launch clutch 157, TC 155, transmission 160, and other components.

Sensors communicating with the controllers and CAN 210 may, for further example, establish or indicate turbocharger boost pressure, crankshaft position or profile ignition pickup (PIP) signal, engine rotational speed or revolutions per minute (RPM), wheel speeds (WS1, WS2, etc.), vehicle speed sensing (VSS), engine coolant temperature (ECT), intake manifold air pressure (MAP), accelerator pedal position sensing (PPS), brake pedal position sensing (BPS), ignition switch position (IGN), throttle valve position (TP), ambient air temperature (TMP) and component and passenger cabin/compartment temperatures, barometric pressure, engine and thermal management system and compressor and chiller pressures and temperatures, pump flow rates and pressures and vacuums, exhaust gas oxygen (EGO) or other exhaust gas component concentration or presence, intake mass air flow (MAF), transmission gear, ratio, or mode, transmission oil temperature (TOT), transmission turbine speed (TS), torque convertor bypass clutch 157 status (TCC), and deceleration or shift mode (MDE), among others.

With continued reference to FIG. 1, vehicle 100 further includes one or more controllers and computing modules and systems, in addition to MCM/BCM/power electronics 185, which enable a variety of vehicle capabilities. For example, vehicle 100 may incorporate a body control module and/or a body system controller, such as a vehicle system controller (VSC) 200 and a vehicle computing system (VCS) and controller 205, which are in communication with MCM/BCM 185, other controllers, and a vehicle network such as a controller area network (CAN) 210, and a larger vehicle control system and other vehicle networks that include other micro-processor-based controllers as described elsewhere herein. CAN 210 may also include network controllers in addition to communications links between controllers, sensors, actuators, and vehicle systems and components.

While illustrated here for purposes of example, as discrete, individual controllers, MCM/BCM 185, VSC 200 and VCS 205 may control, be controlled by, communicate signals to and from, and exchange data with other controllers, and other sensors, actuators, signals, and components that are part of the larger HEV and control systems and internal and external networks. The capabilities and configurations described in connection with any specific micro-processor-based controller(s) as contemplated herein, may also be embodied in one or more other controllers and distributed across more than one controller such that multiple controllers can individually, collaboratively, in combination, and cooperatively enable any such capability and configuration. Accordingly, recitation of “a controller” or “the controller(s)” is intended to refer to such controllers both in the singular and plural connotations, and individually, collectively, and in various suitable cooperative and distributed processing and control combinations.

Further, communications over the network and CAN 210 are intended to include responding to, sharing, transmitting, and receiving of commands, signals, data, control logic, and information between controllers, and sensors, actuators, controls, and vehicle systems and components. The controllers communicate with one or more controller-based input/output (I/O) interfaces that may be implemented as single integrated interfaces enabling communication of raw data and signals, and/or signal conditioning, processing, and/or conversion, short-circuit protection, circuit isolation, and similar capabilities. Alternatively, one or more dedicated hardware or firmware devices, controllers, and systems on a chip may be used to precondition and preprocess particular signals during communications, and before and after such are communicated.

In further illustrations, MCM/BCM 185, VSC 200, VCS 205, CAN 210, and other controllers, may include one or more microprocessors or central processing units (CPU) in communication with various types of computer readable storage devices or media. Computer readable storage devices or media may include volatile and nonvolatile storage in read-only memory (ROM), random-access memory (RAM), and non-volatile or keep-alive memory (NVRAM or KAM). NVRAM or KAM is a persistent or non-volatile memory that may be used to store various commands, executable control logic and instructions and code, data, constants, parameters, and variables needed for operating the vehicle and systems, while the vehicle and systems and the controllers and CPUs are unpowered or powered off. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing and communicating data.

With attention invited again to FIG. 1, vehicle 100 also may include VCS 205 to be the SYNC onboard vehicle computing system manufactured by the Ford Motor Company (See, for example, U.S. Pat. No. 9,080,668). Vehicle 100 also may include a powertrain control unit/module (PCU/PCM) 215 coupled to VSC 200 or another controller, and coupled to CAN 210 and engine 115, and M/G 120 to control each powertrain component. An engine control module (ECM) or unit (ECU) or energy management system (EMS) 220 may also be included having respectively integrated controllers and be in communication with CAN 210, and is coupled to engine 115 and VSC 200 in cooperation with PCU 215 and other controllers.

The disclosure also incorporates in any of the various controllers and/or as another specific controller, a virtual driver system (VDS) 225, which is configured to enable various assistive driving capabilities that may include, for example, such as those contemplated and described in part in Society of Automotive Engineering (SAE) Standard J3016 level 3 (conditional automation) and level 4 (high automation). These examples of VDS 225 contemplates an autonomous and/or virtual driver that enables assistive driving capabilities, as well as semi-autonomous and autonomous operations including, for example, maintaining a constant-speed (CS) while traversing a fixed distance.

In these configurations and variations, VSC 200, VCS 205, VDS 225, and other controllers cooperatively manage and control the vehicle components and other controllers, sensors, and actuators. For example, the controllers may communicate control commands, logic, and instructions and code, data, information, and signals to and/or from engine 115, disconnect clutch 125, M/G 120, TC 155, transmission 160, batteries 175, 180, and MCM/BCM/power electronics 185, and other components and systems. The controllers also may control and communicate with other vehicle components known to those skilled in the art, even though not shown in the figures. The embodiments of vehicle 100 in FIG. 1 also depict exemplary sensors and actuators in communication with vehicle network and CAN 210 that can transmit and receive signals to and from VSC 200, VCS 205, and other controllers.

In further examples, vehicle 100 may include an accelerator position and motion sensor 230, a brake pedal position and motion sensor 235, and other driver controls 240 that may include steering wheel position and motion sensors, driver turn signal position sensors, driver selectable vehicle performance preference profiles and parameters, and driver selectable vehicle operational mode sensors and profile parameters and settings. Further, vehicle 100 may have VCS 205 configured with one or more communications, navigation, and other sensors, such as a vehicle to vehicle communications system (V2V) 245, and roadway infrastructure to vehicle communication system (I2V) 250, a LIDAR/SONAR (light, radar, and/or sound detection and ranging) and/or video camera roadway proximity imaging and obstacle sensor system 255, a GPS or global positioning system 260, and a navigation and moving map display and sensor system 265. The VCS 205 can cooperate in parallel, in series, and distributively with VSC 200, VDS 225, and other controllers to manage and control the vehicle 100 in response to sensor and communication signals identified, established by, communicated to, and received from these vehicle systems and components.

The HEV 100 of the present disclosure also enables VDS 225 to control certain assistive driving capabilities during constant-speed, open-road, distance driving circumstances, which may improve fuel economy as well as battery charge-discharge and charge-cycling efficiency. The virtual driver enabled by VDS 225 and other controllers, is configured to determine and adjust optimal power for HEV engine 115 and electric machine/motor/generator (M/G) 120, and output wheel-torque-power (WT, FIGS. 1, 3, where the arrow labeled WT represents wheels turning in response to wheel torque power) settings and high-voltage (HV) battery 175 charging rates or battery-power, and battery state-of-charge (SoC), among other capabilities, for such constant-speed, distance configurations.

With continuing reference to the various figures, and now also with specific attention to FIGS. 1, 2, and 3, the HEV 100 according to the disclosure includes ICE 115, M/G 120, and HV battery 175, coupled to one or more controller(s), such as VSC 200, VCS 205, and VDS 225, which are configured to generate and to respond to a virtual-driver signal (VS) 270, which may initiate a virtual-driver that enables assistive, semi-autonomous, and/or autonomous driving capabilities. The controllers may also generate various other signals (OS) 275 and HEV control signals (CTS) 280, which are utilized to communicate data to and from various HEV components, sensors, systems, and controllers. Further, the controllers may embed information in and extract information from VS 270, OS 275, and CTS 280, and may also communicate directly with vehicle controllers, sensors, actuators, systems, and components, to enable various VDS 225 operations.

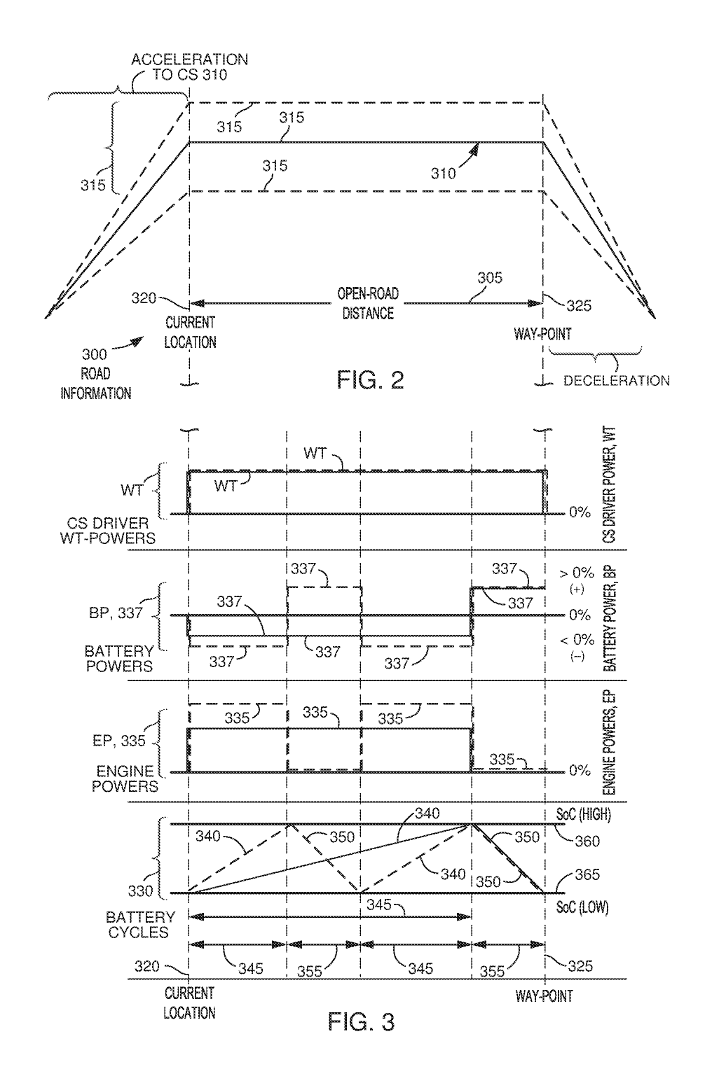

Such embedded and extracted information may include, for example, road information (RI) 300 (FIG. 2) that may include way-points, obstacles, traffic data, other vehicle V2V 245 data, and infrastructure I2V 250 broadcast data and alerts, among other types of data. Such embedded and/or extracted information may also be included and/or derived from raw sensor data from vehicle sensors and components, including for example HV battery 175, MCM/BCM 185, and others. In yet additional examples, such embedded and/or extracted information may be derived, for example, from sensors and components including pedals/sensors 230, 235, driver controls 240 (turn signals, steering position and motion, etc.), V2V 245, I2V 250, roadway imaging and obstacle sensors 255, moving map system 265 and other sensors.

With such further information, VCS 205, VDS 225, and other controllers may identify, detect, predict, and generate open-road distances 305 (FIG. 2) that may be suitable for VDS 225 control. The controller(s), such as VSC 200, VDS 225, PCU 215, BCM 185, and/or other controllers may then generate OS 275 and CTS 280 to enable powertrain 110 to maintain a constant-speed (CS) 310 (FIG. 2) over the open-road distance 305. In response to VS 270, the controller(s) are configured to determine CS 310 for HEV 100, a predicted and/or generated distance, such as open-road distance 305, and a predicted wheel-torque-power WT.

The predicted wheel-torque-power WT, for purposes of illustration and example, may be the resultant, net torque delivered to the wheels 154 from an engine-power (EP) generated by ICE 115 and battery-power (BP) generated by M/G 120 after frictional and related torque losses arising during torque conditioning and transmission driveline 105. The controllers also predict, establish, and maintain the HEV CS 310 from a plurality of candidate speeds and/or a range of speeds 315 (FIG. 2), which are derived from and which have a lowest fuel consumption, and when appropriate and possible a minimum number of battery-charge-cycles, for the predicted distance 305, engine power EP, battery power BP, and wheel-torque-power WT (vehicle propulsive power). The controller(s) generate the predicted distance 305, from one or more of GPS and position sensors and displays 255, 260, and navigational and moving-map sensors and displays 265, which establish, receive, store RI 300 for the current and predicted future HEV positions or locations, such as way-point 325.

A current location 320 (FIGS. 2 and 3) of HEV 100 is determined to identify, establish, predict, and generate open-road distance 305 between current location 320 and at least one detected and/or predetermined way-point 325. The current location 320 may typically be predicted, identified, and determined to be any point at which CS 310 may commence, after an acceleration (FIG. 3) of HEV 100 up to CS 310. The detected or predetermined way-point 325 may usually be the point at which CS 310 is discontinued and deceleration or acceleration begins (FIG. 3), and after which HEV 100 travels some additional distance until changed to another speed and/or stopped. The open-road distance may be detected by the controller(s) from RI 300, on road segments that do not have selected, identifiable, and/or detectable way-points, obstacles, traffic congestion, and other such features. These may include, for example, user-preselected way-point locations, roadway intersections, road construction, and other road obstacles that likely may or will require the HEV to discontinue CS 310 and to later change speed or stop some time and distance after way-point 325 when CS 310 is discontinued.

Each of such possible and/or planned way-points, such as way-point 325, may be identified by the controllers and/or by a user of HEV 100, and may be derived, communicated, and detected by and with V2V 245, I2V 250, proximity/imaging sensors 255, navigation/moving-map sensors and system and displays 265, and other components. Similarly, these controller(s) and subsystems may also predict the distal-way-point 325 of the open-road distance 305, which distal-way-point 325 may be any of the noted likely future HEV locations at which CS 310 may end, which may precede a later speed change or stop. The CS 310 is also thereby predicted, derived, and maintained by the controller(s) by evaluating travel-times (distance 305 divided by candidate CSs 315, FIG. 2) and predicted battery-charge-discharge cycles 330 (FIG. 3) for candidate or range of CSs 315 over predicted distance 305. In variations of the disclosure, any range of distances 305 may be predicted and generated, which may be any distance without limitation, such that the benefits contemplated here may be realized. For example, it has been found that a range of between about 4 to about 10 miles and/or kilometers, and greater distances 305 can be sufficient distances within which the possible CS-enabled advantages may be realized, even though such benefits result from any distances 305.

The candidate speeds or range of speeds 315 are predicted and maintained by the controllers as possible speeds that may be available over the distance 305, from V2V 245, moving map sensor 265, posted speed limits of RI 300 and/or I2V 250, detected speeds of other vehicles on the road from proximity/imaging sensor 255, and other subsystems. For example, if a posted speed limit is 70 miles per hour (MPH) or 115 kilometers per hour (KPH), then the plurality of speeds may be the range or bracketed or incremental group or range of speeds 315 of 65, 67, 70, 73, 75 MPH, or 111, 113, 115, 117, 119 KPH, and may include fewer or more such candidate speeds 315. Each of these speeds in the range may be suitable for use as CS 310 during travel over predicted distance or open-road distance 305, and may enable VDS 225 to incrementally speed up and slow down HEV 100 to navigate about road conditions and around nearby vehicles, obstacles, and traffic congestion, while VDS 225 is engaged and controlling CS 310 and other systems of HEV 100. Although a wide range of possible speeds may enable contemplated fuel and battery-cycling savings, a range of speeds between about 35 and about 75 MPH, or about 40 to 125 KPH, or higher or lower, may enable the CS-related benefits of the disclosure.

VDS 225 and other controllers cooperate to predict and control an engine-power EP, 335, and battery-power, BP, 337 (FIG. 3), which are predicted for each candidate speed 315 of the plurality and the predicted/maintained CS 310, and which engine-power 335 and battery-power 337 are required for HEV 100 to maintain CS 310, while also powering vehicle accessories, and sustaining a charge-rate or charge-cycle for HV battery 175. The predicted engine-power 335 and battery-power 337 are utilized by the controller(s) to command ICE 115 and M/G 120, to minimize fuel consumption and the number of battery-charge-cycles 330, as HEV travels over the predicted distance 305. After first predicting or establishing virtual or autonomous driver demand for CS 310, wheel-torque-power WT or vehicle propulsive power is also established by the controller(s) from and as a function of the CS 310 and power needed for vehicle accessories. In one exemplary configuration, which may be understood with reference to FIG. 3 (not drawn to scale), HEV 100 achieved the contemplated improvements while maintaining a predicted and maintained CS 310, while traveling on a substantially flat open-road distance 305, while expending between about 7.5 kilowatts (KW) and about 9 KW of predicted propulsive battery-power 337 in an electric only propulsion mode of operation. In another variation, while charging battery 175 and propelling HEV 100, ICE 115 produced between about 20 KW and about 24 KW, and on average about 23.6 KW, which enabled a negative M/G torque to generate battery-power 337 for a charge-cycle of about 15 KW for recharging battery 175, and the propulsion engine-power 335 of about 23.6 KW utilized to maintain CS 310, with a wheel-torque-power WT of approximately 8.6 KW or somewhat lower due to losses in driveline 105 and power consumption by vehicle accessories.

The predicted engine-power 335, battery-power 337 and wheel-torque power WT are also derived, established, and determined as a function of one or more operational parameters of HEV 100. The wheel-torque-power WT needed to propel HEV 100 is predicted and established from CS 310 and an aero drag of the vehicle body, a rolling resistance of the wheels 154, uphill and downhill road grade over the predicted distance 305, and concurrent HEV accessory loads, including FEAD accessories, which are likely to be required and to consume engine-power 335 and battery power 337, while the VDS 225 virtual or auto driver maintains CS 310. For purposes of illustration, but not limitation, the CS 310 driver demand or wheel-torque power, the engine-power 335 and battery-power 337 are represented schematically as relative magnitude lines of FIG. 3, and include dashed lines to represent one possible variation of magnitudes of the contemplated plurality (not to scale), while the solid lines represent another possible variation of magnitudes, also of the plurality (also not to scale). As should be understood by those knowledgeable in the field of technology, and in view of engineering convention and choice that defines and assigns positive and negative connotations to power expending and generated, the battery powers 337 may, for purposes of illustration here, reflect positive magnitudes greater than 0% power when the HV battery 175 is discharging power to M/G 120 to propel HEV 100, and may reflect negative magnitudes less than 0% power when ICE 115 drives both M/G 120 to generate power to recharge HV battery 175 while also propelling HEV 100.

The plurality of battery-charge-discharge-cycles or battery-cycles and candidate cycles 330 may also be predicted by the controller(s), using each of the respective travel-times, as well as minimum and maximum battery-charge-discharge powers and rates. The predicted battery-charge-discharge cycles and/or candidate battery cycles 330 include, for example, one or more battery cycles 330 required for the HEV to travel over predicted distance 305. The candidate battery cycles 330 may be predicted and established as a reasonable number of such cycles that can occur over the predicted distance 305 at the CS 310. Such candidate battery cycles 330 may be predicted and established as a function of a number of parameters, which may include, for example without limitation, the time to travel the distance 305, the electric only vehicle time (during discharge cycles 350 over sub-distances 355), the SoC range between high SoC 360 and low or minimum SoC 365, a maximum charge power limit of the HV battery 175 and the battery maximum charge and discharge rates per time or rates of change in the SoC over time, among other parameters.

The time to charge the HV battery 175 may be predicted and established from, among other possible parameters, the time to travel distance 305 at CS 310 less the electric only time during which HV battery 175 is discharging to propel HEV 100 at CS 310. Those with knowledge in the field of technology may also be able to comprehend that the electric only times of battery discharge cycles 350 are predicted and established as a function of the minimum and maximum SoCs 360, 365, and the wheel-torque-power WT needed to maintain CS 310 over the distance 305. In turn, the power needed to charge HV battery 175 is predicted and established from the range of minimum and maximum battery SoCs 360, 365, and the time to charge HV battery 175. The engine power EP, 335, during battery charging is then predicted and established also as a function of the needed wheel-torque-power WT and battery charge power BP, 337. Although the virtual driver capability seeks to minimize fuel consumption to minimize cost of operation of HEV 100 over the distance 305 during CS 310 operation, it may also be of benefit to minimize the number of battery-charge-discharge cycles, which can improve the life span of the batteries.

In this arrangement, for example, ICE 115 propels HEV 100 and powers M/G 120 to produce negative torque to charge battery 175 during charge-cycles 340 and charge sub-distances 345 (FIG. 3). Similarly, ICE 115 is powered off and battery 175 discharges while powering M/G 120 to propel HEV 100, during discharge cycles 350 over discharge sub-distances 355. An exemplary charge-cycle 340 and discharge-cycle 350 of the plurality are represented by the dashed lines of FIG. 3 (not to scale), while a different, longer charge-cycle 340 and discharge-cycle 350 (also not to scale) of the plurality are further depicted by the solid lines. For purposes of illustration, and although not to scale, the dashed and solid charge-cycle 340 and discharge-cycle 350 lines approximately correspond with the dashed and solid engine-power 335 lines, also in FIG. 3. It should also be apparent to those familiar with the technology that the horizontal scale of FIG. 3 schematically represents both distance between the current location 320 and way-point 325, as well as time, since distance is a function of speed and time.

The longer charge-cycle 340 may in certain circumstances minimize the number of battery-charge-discharge cycles, and when such is possible in view of the priority to minimize fuel consumption and associated cost. When referred to herein, minimizing battery-charge-discharge cycles is always a secondary consideration. In variations of the disclosure, for purposes of further disclosure but not limitation, it is also contemplated that both fuel consumption and battery-charge-discharge-cycles, as well as other parameters disclosed herein and contemplated by the disclosure, may be minimized and/or optimized using any number of closed and open-loop functions, which enable prediction, derivation, and establishing the various other control parameters. For example, a cost minimization or optimization function may also be utilized here, wherein minimized cost equals the sum of (i) a first weight-ratio multiplied by a fuel consumption cost function, and (ii) a second weight-ratio multiplied by a battery-charge-discharge, life-cycle cost function.

The respective weight-ratios can assign a preferred weight to each of the fuel cost and battery life-cycle cost functions. The fuel-cost and battery life-cycle cost functions can determine/predict the cost of fuel for each predicted distance 305 and CS 315, as well as the cost of the battery degradation, if any, for each battery cycle. The cost for each battery cycle may be the cost to replace the battery(ies) 175 after some predetermined, maximum number of charge-discharge cycles have occurred. This approach may be utilized with any of the other described and contemplated parameters to enable optimization (minimization, maximization, etc.) of the described virtual driver capabilities. For further example, the first weight-ratio may be selected to be, for purposes of illustration but not limitation, ninety percent, such that the second weight-ratio would be 100% less 90%, or 10%. In this example, the fuel consumption is predicted and established to have a greater effect upon, or more important, influential, or relevant to the cost optimization than that of the battery life cycle according to the exemplary weight-ratios.

Typically, the controllers monitor battery 175 and adjust M/G 120 to generate charging, negative torque to maintain battery 175 between a high or maximum SoC 360 and a minimum or low SoC 365 (FIG. 3). The controller(s), such as BCM 185, utilize(s) predetermined and/or known performance parameters for battery 175 to determine and predict the time and distance needed to charge battery 175, and discharge power available to propel HEV 100, such that a plurality of battery cycles and candidates cycles 330, such as the battery cycles 340, 350 can be predicted by the controllers. Described differently, the controller(s), such as VDS 225, adjust M/G or electric machine 120 to supply the required wheel-torque-power WT using battery power until battery 175 is discharged to the predetermined minimum SoC 365, and to then adjust ICE 115 and M/G 120 to produce engine-power 335 and wheel-torque-power WT while also driving M/G 120 for recharging battery 175. With this predicted battery cycle information, the controller(s) can then derive and predict the minimum fuel consumption and battery cycles 330 needed for HEV 100 to traverse the predicted distance 305.

With these arrangements, the controller(s) also are configured to predict and/or derive a plurality of such WTs, engine-powers 335, and battery-powers 337, which are respectively required for each of the battery-charge-discharge-cycles 330, 340, 350 and the required WT power needed to propel HEV 100. Using these predicted parameters and associated travel-times, the controller(s) then also establish a plurality of respective fuel consumptions for each predicted or derived engine-power 335 of the plurality, using specific-fuel-consumption rates that can be identified, established, and/or derived from a fuel consumption map for ICE 115, such as a brake-specific-fuel-consumption map or other type of fuel consumption map, which should be known to those skilled in the field of technology. Thereafter, the controller(s) predict, maintain, and identify CS 310 from the plurality of candidate or range of CSs 315, which has the lowest fuel consumption and possibly also the minimum number of battery-charge-cycles 330 of the respective pluralities. In the example described elsewhere herein, ICE 115 exhibited a fuel consumption of about 60 miles per gallon or about 96 kilometers per gallon, while generating the noted 23.6 KW, which, for one candidate example and for purposes of illustration, was demonstrated to be lower than a comparably configured HEV 100 being driven manually, without implementation of the assistive/semi-autonomous CS 310 capability.

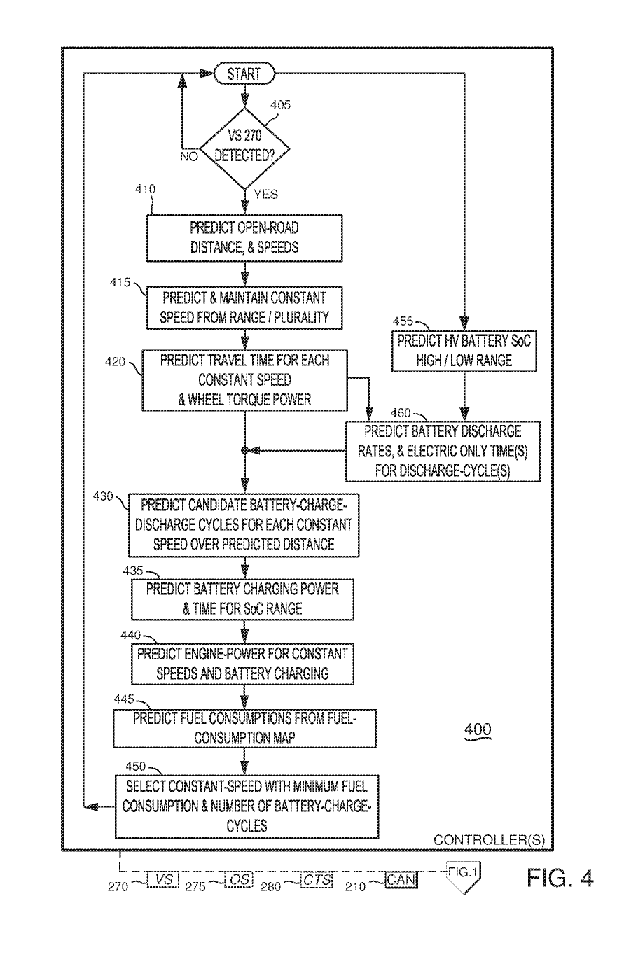

With continuing reference to the previously described figures, and now also to FIG. 4, it may be understood that the various arrangements and modifications of the disclosure also contemplate methods of operation of HEV 100, which incorporate control logic and processes 400 that are initiated for such operation. For purposes of further example, but not for limitation, the VDS 225 and other controller(s) are configured at a step 405 to respond to VS 275, which upon detection, enables predicting at step 410 a driving distance, such as the open-road distance 305, and the range of possible speeds 315. CS 310 is predicted, maintained, and/or generated at step 415 from the plurality or range of possible speeds 315 over the predicted distance 305. As described elsewhere, CS 310 is maintained, predicted, and/or derived to have the lowest fuel consumption and minimum number of battery-charge-cycles 330, for the predicted distance 305, wheel-torque-power WT, engine-power 335, and battery-powers 337.

The methods further include, by the controller(s), predicting distance 305 also at step 410, from one or more of position/GPS 260 and moving-map sensors 265, by detecting the current location 320, and identifying from the moving-map sensors 265 and others the open-road distance 305 between the current location 320 and at least one predetermined and/or predicted way-point 325. HEV 100 also includes predicting, maintaining, generating, and establishing at step 415, by the controller(s), the plurality of CSs 310 from the range of speeds 315 available for the predicted distance 305. As before, the range of speeds 315 is established from the one or more of position and moving-map sensors 260, 265 and others, and deriving, predicting, and/or generating at step 420 respective travel-times for each of the plurality of CSs 310, and wheel torque powers WT. The wheel torque powers WT are also predicted, established, and maintained as a function of, among other parameters, aero drag, rolling resistance, road grade, and concurrent accessory loads.

The controller(s) of the methods execute at step 430, logic instructions for predicting the plurality of battery-charge-cycles and candidate cycles 330 including lowest possible or minimum number of battery-charge-cycles 330 from the plurality, over the distance 305, as also described elsewhere herein, using each respective travel-time and constant speed 310, which enables the electric machine/M/G 120 to supply the respective required CS virtual driver demanded powers or wheel-torque-powers WTs, which are also referred to as vehicle propulsive powers. At step 435, the controllers execute the step of predicting and deriving from the preceding data, the battery charging powers 337 and times needed for each contemplated charge cycle. During step 440, the controllers execute logic for predicting engine-powers 335 for each CS 310 and wheel-torque-power WT, needed for distances 305, speeds 315, and each battery-charge-cycle 340 (and vehicle accessories). The controllers also execute step 445 for establishing a plurality of fuel consumptions for each predicted engine-power 335 of the plurality, derived from and using the specific-fuel-consumption rates from any number of fuel-consumption maps, such as, for example without limitation, the brake-specific-fuel-consumption map. At step 450, the controllers execute the step of predicting, maintaining, or deriving CS 310 that has the lowest fuel consumption from the plurality, and where appropriate and possible, also the lowest number of battery-charge-cycles 330 from the plurality.

In variations of these method steps 400, the controllers may also be configured at step 455 for predicting, establishing, or deriving the SoC minimum or low setting or ranges, and the SoC maximum or high setting or ranges, for HV battery 175. These SoCs can be utilized to predict or establish battery-powers 337, charge-cycles 340 and discharge-cycles 350, and thus recharge times, which may be needed to derive, ascertain, or establish engine-powers 335, and other parameters. The controllers at step 460 also may execute the step of predicting, deriving, or establishing discharge rates of discharge-cycles 350 of HV battery 175, which can also be utilized for predicting and deriving the various other noted parameters already described, including battery-powers 337, and time for discharge-cycle 350 when on battery power, such as during discharge-distances 355, when HEV 100 is configured for electric only propulsion.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle, comprising:
a controller coupled to an engine, an electric machine, and a battery; and
the controller configured to, in response to a virtual-driver signal,
command the engine and electric machine according to predicted engine and wheel-torque powers, derived from a fuel consumption and battery-charge-cycle for a constant-speed (CS) over a predicted distance, and required for vehicle accessories and a charge-rate, and to maintain the CS over the distance.

2. The vehicle according to claim 1, further comprising:
the controller configured to generate the predicted distance, from one or more of position and moving-map sensors, by detecting a current location, identifying from the moving-map sensors an open-road distance not having detectable way-points, and predicting a distal-way-point of the open-road distance.

3. The vehicle according to claim 2, further comprising:
the controller configured to generate a plurality of CSs from a range of speeds available for the predicted distance, wherein the range of speeds is established from the one or more of position and moving-map sensors.

4. The vehicle according to claim 3, further comprising:
the controller configured to generate respective travel-times for each of the plurality of CSs, and to determine for each travel-time and CS of the pluralities, a respective required wheel-torque-power to maintain the CS and as a function of one or more of aero drag, rolling resistance, road grade, and vehicle accessory loads.

5. The vehicle according to claim 4, further comprising:
the controller configured to:
predict a plurality of battery-charge-discharge-cycles, using each respective travel-time, needed to enable the electric machine to supply the required wheel-torque-power,
predict a plurality of engine-powers needed for each battery-charge-cycle and required wheel-torque-power, and
establish a plurality of fuel consumptions for each predicted engine-power of the plurality, using fuel-consumption rates from a fuel-consumption map.

6. The vehicle according to claim 5, further comprising:
the controller configured to identify the CS from the plurality of CSs to have the lowest fuel consumption and the minimum number of battery-charge-cycles of the respective pluralities.

7. The vehicle according to claim 1, further comprising:
the controller configured to generate the predicted distance, from one or more of position and moving-map sensors, by detecting a current location, and identifying an open-road distance between the current location and at least one predetermined way-point.

8. The vehicle according to claim 7, further comprising:
the controller configured to generate a plurality of CSs from a range of speeds available for the predicted distance, wherein the range of speeds is established from the one or more of position and moving-map sensors.

9. The vehicle according to claim 8, further comprising:
the controller configured to:
generate respective travel-times for each of the plurality of CSs, and
determine for each travel-time and CS of the pluralities, a respective required wheel-torque-power to maintain the CS and as a function of aero drag, rolling resistance, road grade, and concurrent accessory loads.

10. The vehicle according to claim 9, further comprising:
the controller configured to:
predict a plurality of battery-charge-discharge-cycles, using each respective travel-time, needed to enable the electric machine to supply the required wheel-torque-power,
predict a plurality of engine-powers needed for each battery-charge-cycle and required wheel-torque-power, and
establish a plurality of fuel consumptions for each predicted engine-power of the plurality, using fuel-consumption rates from a fuel-consumption map.

11. The vehicle according to claim 10, further comprising:
the controller configured to identify the CS from the plurality of CSs to have the lowest fuel consumption and the minimum number of battery-charge-cycles of the respective pluralities.

12. A vehicle, comprising:
a controller coupled to an engine, an electric machine, and a battery, and configured to, in response to a virtual-driver signal,
command the engine and electric machine to maintain:
a constant-speed (CS) of a plurality over a predicted distance, and
predicted engine and wheel-torque powers required for vehicle accessories and a charge-rate, and derived from a fuel consumption and number of battery-charge-cycles for the CS.

13. The vehicle according to claim 12, further comprising:
the controller configured to generate the predicted distance, from one or more of position and moving-map sensors, by detecting a current location, and identifying from the moving-map sensors an open-road distance between the current location and at least one predetermined way-point.

14. The vehicle according to claim 13, further comprising:
the controller configured to generate the plurality of CSs from a range of speeds available for the predicted distance, wherein the range of speeds is established from the one or more of position and moving-map sensors.

15. The vehicle according to claim 14, further comprising:
the controller configured to:
generate respective travel-times for each of the plurality of CSs, and
determine for each travel-time and CS of the pluralities, a respective required wheel-torque-power to maintain the CS and as a function of aero drag, rolling resistance, road grade, and concurrent accessory loads.

16. The vehicle according to claim 15, further comprising:
the controller configured to:
predict a plurality of battery-charge-discharge-cycles, using each respective travel-time, needed to enable the electric machine to supply the required wheel-torque-power,
identify the lowest number of battery-charge-cycles from the plurality,
predict a plurality of engine-powers needed for each battery-charge-cycle and required wheel-torque-power,
establish a plurality of fuel consumptions for each predicted engine-power of the plurality, using fuel-consumption rates from a fuel-consumption map, and
maintain the constant-speed of the plurality having lowest fuel consumption.

17. A method of controlling a vehicle, comprising:
commanding an engine and an electric machine, and maintaining by a controller, in response to a virtual-driver signal,
a constant speed from a plurality over a predicted distance, and
predicted engine and wheel-torque powers, required for vehicle accessories and a charge-rate, and derived from a fuel consumption and a number of battery-charge-cycles.

18. The method according to claim 17, further comprising:
by the controller:
generating the predicted distance, from one or more of position and moving-map sensors, by
detecting a current location, and
identifying from the moving-map sensors an open-road distance between the current location and at least one predetermined way-point.

19. The method according to claim 18, further comprising:
by the controller:
generating the plurality of constant-speeds (CSs) from a range of speeds available for the predicted distance, wherein the range of speeds is derived from the one or more of position and moving-map sensors:
generating respective travel-times for each of the plurality of CSs; and
predicting for each travel-time and constant-speed of the pluralities, a respective required wheel-torque-power to maintain the CSs and as a function of aero drag, rolling resistance, road grade, and concurrent accessory loads.

20. The method according to claim 19, further comprising:
by the controller:
predicting a plurality of battery-charge-discharge-cycles, using each respective travel-time, needed to enable an electric machine to supply the required wheel-torque-power;
predicting a plurality of engine-powers needed for each battery-charge-cycle and required wheel-torque-power;
establishing a plurality of fuel consumptions for each predicted engine-power of the plurality, using fuel-consumption rates from a fuel-consumption map; and
maintaining the constant-speed having the lowest fuel consumption and battery-charge-cycle from the pluralities.
